(19) United States
(12) Patent Application Publication
(10) Pub. No.: US 2008/0041121 A1
(43) Pub. Date: Feb. 21, 2008

(54) LOCK

(75) Inventors: Yifeng Chen, Hong Kong (CN); Hay To Chu, Hong Kong (CN)

Correspondence Address: BLAKELY SOKOLOFF TAYLOR & ZAFMAN, 1279 OAKMEAD PARKWAY, SUNNYVALE, CA, 94085-4040, US

(73) Assignee: Victory Dragon International Industrial Company Limited, Hong Kong (CN)

(21) Appl. No.: 11/771,858

(22) Filed: Jun. 29, 2007

Related U.S. Application Data
(63) Continuation-in-part of application No. 11/613,139, filed on Dec. 19, 2006.

(30) Foreign Application Priority Data
Dec. 19, 2005 (CN) 200520146399.0
Dec. 28, 2005 (CN) 200520006623.6

(51) Int. Cl. E05B 63/00; E05B 65/48

(52) U.S. Cl. 70/1; 70/2

(57) ABSTRACT

A mechanical counting device (25) provided within a lock (20), the lock (20) including a latch (26) and a hasp (22), wherein when the latch (26) is engaged with the hasp (22), the lock (20) is locked, and when the hasp (22) is released from the latch (26), the lock (20) is unlocked, the counting device (25) comprising: an actuator (5) to actuate in response to the hasp (22) engaging with the latch (26); and a visual indication (10) to visually indicate whether the lock (20) has been relocked; wherein each actuation of the actuator (5) causes the visual indication (10) to alter and indicate that the lock (20) has been relocked another time.

### CROSS-REFERENCE TO RELATED APPLICATIONS

This is a continuation-in-part of prior U.S. patent application Ser. No. 11/613,139, filed on Dec. 19, 2006, which claims priority from Chinese Patent Application No. 200520146399.0, filed on Dec. 19, 2005 and Chinese Patent Application No. 200520006623.6, filed on Dec. 28, 2005, each of which is incorporated herein by reference in its entirety.

### TECHNICAL FIELD

The invention concerns a mechanical counting device for a lock, and an improved lock.

### BACKGROUND OF THE INVENTION

Locks are used in many different situations to prevent unauthorized opening of secure items, such as doors, windows, containers, cargo and bags. Locks may be a simple mechanical device, or be sophisticated and contain some electronic components.

Typically, to increase the security of a lock, additional lock combinations are incorporated. However, this increases the cost per lock unit and also the copying costs for additional keys by the owner. Although the unlocking combination of the lock is complex; it still does not prevent unauthorized third parties, for example, a thief, to unlock and relock the lock later without the owner being aware that the lock has been unlocked and relocked by merely looking at the lock.

Further, traditional counting devices for locks typically have a large structure with complex components. Also, miscounting occurs sometimes due to the complexity and there may be a higher chance of parts failure.

There is a desire for a locking device that has a visual indication of whether a lock has been relocked at least once which also ameliorates some of the abovementioned problems.

### SUMMARY OF THE INVENTION

In a first preferred aspect, there is provided a mechanical counting device provided within a lock, the lock including a latch and a hasp, wherein when the latch is engaged with the hasp, the lock is locked, and when the hasp is released from the latch, the lock is unlocked, the counting device comprising:
an actuator to actuate in response to the hasp engaging with the latch; and
a visual indication to visually indicate whether the lock has been relocked;
wherein each actuation of the actuator causes the visual indication to alter and indicate that the lock has been relocked another time.

The actuator may be pivotally connected to rotational lever biased by a spring, and actuation of the actuator causes the rotational lever to incrementally rotate the visual indication.

The visual indication may be a numeric counter.

The device may be provided at the base of the lock, and the visual indication is visible through a transparent portion at the base of the lock.

The device may further comprise:
lateral sidewalls;
a counting gear;
a counting rotation lever;
a stop lever to stop the counting gear returning back to its original position when the actuator is actuated; and
a carry-over pinion;
wherein actuating the actuator causes the counting rotation lever to move and the counting gear to rotate, a counting gear spindle is reset back to zero, the carry-over pinion is propped against and driving the counting gear to perform carry-over, and an elastic plate is propped against a carry-over pinion spindle to move within a hole in the lateral sidewalls.

In a second aspect, there is provided a lock comprising:
a latch and a hasp, wherein when the latch is engaged with the hasp, the lock is locked, and when the hasp is released from the latch, the lock is unlocked; and
a mechanical counting device having an actuator to actuate in response to the hasp engaging with the latch, and having a visual indication to visually indicate whether the lock has been relocked;
wherein each actuation of the actuator causes the visual indication to alter and indicate that the lock has been relocked another time.

The lock may further comprise an elongate member to be pushed by the hasp to actuate the actuator when the latch engages the hasp.

In a third aspect, there is provided a device to be operatively connected to a lock, the device being mechanically actuated in response to relocking the lock, the device comprising:
a visual indication to visually indicate that the lock has been relocked at least once;
an actuator to actuate the visual indication;
wherein relocking the lock causes the actuator to actuate the visual indication to visually indicate that the lock has been relocked at least once.

The device may comprise a housing having a transparent portion to enable the visual indication to be seen.

The actuator may be an elongate arm extending through an aperture formed in the housing, the arm being pushed inwardly to actuate the visual indication.

The arm may be biased by a spring to partially extend out from the housing via an aperture.

In a fourth aspect, there is provided a method for unlocking a lock, the method comprising:
visually indicating that the lock has been relocked at least once using a visual indication;
actuating the visual indication;
wherein locking the lock causes the actuator to actuate the visual indication to visually indicate that the lock has been relocked at least once.

Advantageously, a reliable and safe lock is provided. A mechanical counter is provided within the lock and a visual portion of the lock displays a record of the relocking history of the lock if the lock has been relocked by another person. If a numeric counter is used, the number of times it has been relocked will also be displayed. The mechanical counter may be a numeric counter that increments, or a color or text indication to indicate if the lock has been relocked.

### BRIEF DESCRIPTION OF THE DRAWINGS

An example of the invention will now be described with reference to the accompanying drawings, in which:

FIG. 1 is a front top perspective view of a mechanical counting device in accordance with a first embodiment of the present invention with its cover removed;

FIG. 2 is a rear top perspective view of the device of FIG. 1;

FIG. 3 is a bottom perspective view of the device of FIG. 1 with its cover installed;

FIG. 4 is a bottom plan view of the device of FIG. 1;

FIG. 5 is a first lateral side plan view of the device of FIG. 1;

FIG. 6 is a front side plan view of the device of FIG. 1;

FIG. 7 is a first lateral side plan view of the device of FIG. 1;

FIG. 8 is a sectional side view of the device of FIG. 1;

FIG. 9 is a top plan view of the device of FIG. 1 with its cover installed;

FIG. 10 is a perspective view of a lock having the mechanical counting device of FIG. 1;

FIG. 11 is a sectional front view of the lock of FIG. 10; and

FIG. 12 is a series of views of a mechanical counting device in accordance with a second embodiment of the present invention.

### DETAILED DESCRIPTION OF THE DRAWINGS

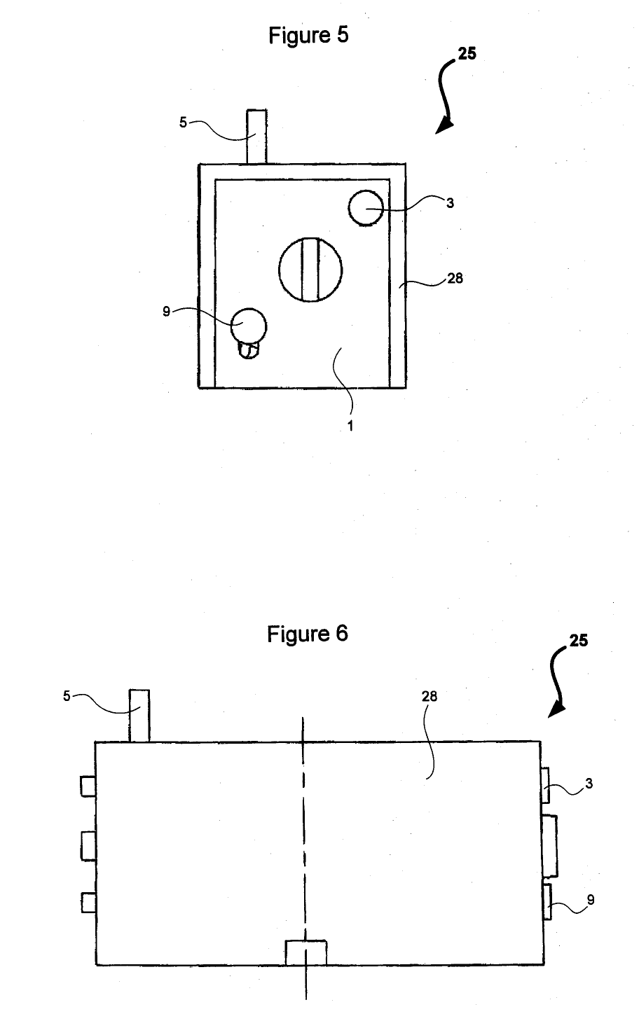

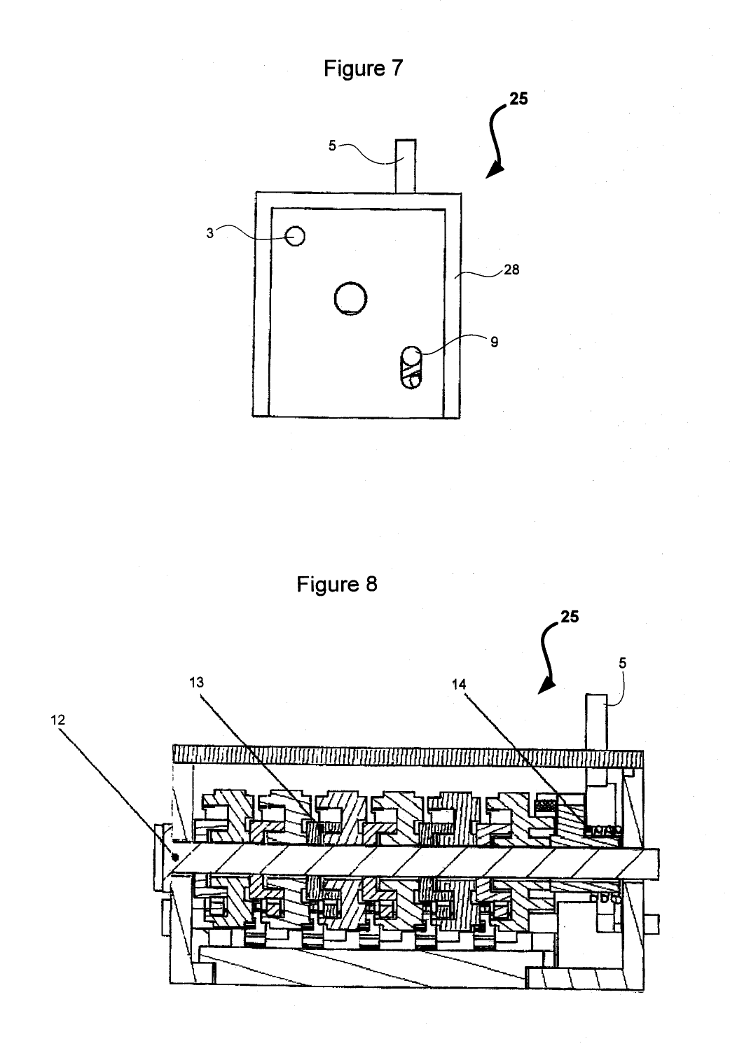

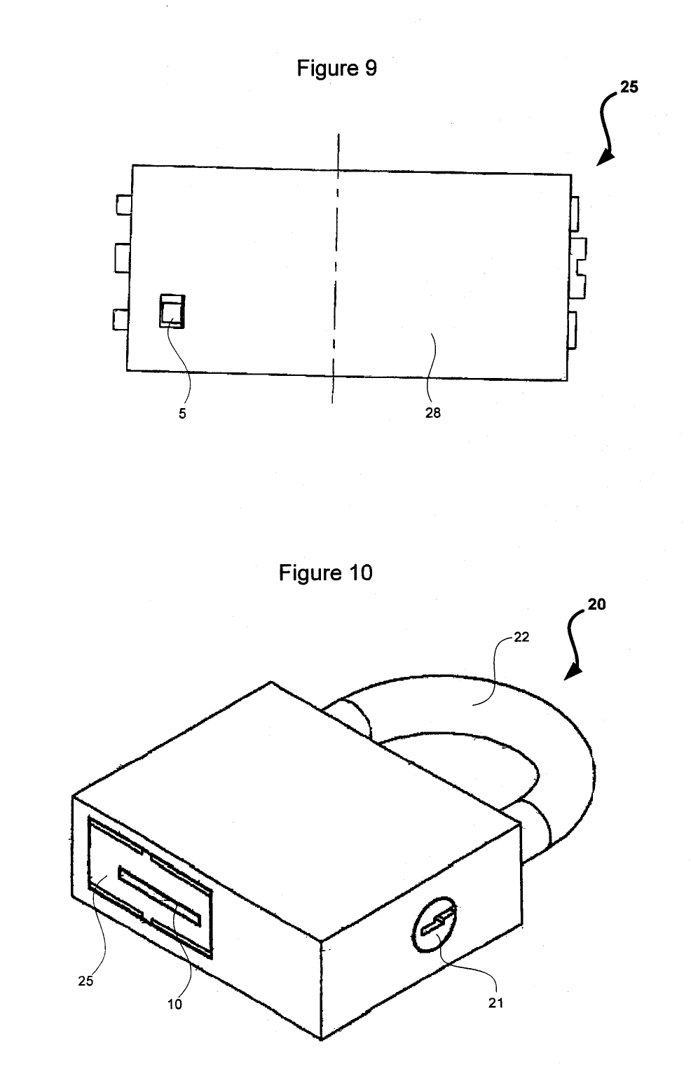

Referring to the drawings, a mechanical counting device 25 for a lock 20 is provided. The lock 20 includes a latch 26 and a hasp 22. When the latch 26 is engaged with the hasp 22, the lock 20 is locked. When the hasp 22 is released from the latch 26, the lock 20 is unlocked. The counting device 25 generally comprises: an actuator 5 and a visual indication 10. The actuator 5 actuates in response to the hasp 22 engaging with the latch 26. The visual indication 10 visually indicates whether the lock 20 has been relocked. Each actuation of the actuator 5 causes the visual indication 10 to alter and indicate that the lock 20 has been relocked another time. Preferably, the visual indication 10 is a numeric counter. However, the visual indication 10 may be colors or text indication to indicate if the lock 20 has been relocked. Typically, the counting device 25 has a cover 28 covering its front, top and rear sides as seen in FIGS. 3 to 7 and 9.

The counting device 25 has lateral sidewalls 1, a counting gear 2, and a counting rotation lever 4. The counting device 25 also has: a stop lever 6 to stop the counting gear 2 returning back to the original position when the actuator 5 is actuated, and a carry-over pinion 8. When the actuator 5 is actuated, the counting rotation lever 4 moves causing the counting gear 2 to rotate. A counting gear spindle 12 is reset back to zero. The carry-over pinion 8 is propped against and driving the counting gear 2 to perform any carry-over. An elastic plate 7 is propped against a carry-over pinion spindle 9 to move within a hole/groove in the lateral sidewalls 1.

The counting gear spindle 12, stop spindle 3, carry-over pinion spindle 9 and elastic plate 7 are mounted onto the lateral sidewalls 1. A visual indication 10 is visible through a transparent portion at a base 11 of the counting device 25. The stop lever 6 is operatively connected to the stop spindle 3. The carry-over pinion 8 is operatively connected to the carry-over pinion spindle 9. The carry-over pinion spindle 9 is floated up downwardly by the force of elastic plate 7 (the rectangular holes are located on the ends of the lateral sidewalls 1). The counting gear 2, counting gear stopper 13 and counting rotation lever 4 are operatively connected to the counting gear spindle 12; and a spring 14 and the actuator 5 are operatively connected to the counting rotation lever 4.

The actuator 5 is actuated when the latch 26 engages the hasp 22. The hasp 22 compresses the spring 23 and pushes an elongate member 27 down to actuate the actuator 5 which causes the counting rotation lever 4 to rotate. The counting rotation lever 4 drives the adjacent counting gear 2 to move at a certain angle and the numbers on the counting gear 2 incrementally shift forward. After the actuator 5 is released, the counting gear rotating lever 4 is biased to its original position by the resilience of the spring 14. The counting gear 2 does not return back to its original position due to the stop lever 6. After each counting gear 2 rotates nine times, the carry-over pinion 8 drives the next counting gear 2 to rotate one time and to carry-over the number. In other words, if the previous counting gear 2 shows a nine, it rotates to become a zero, and the next counting gear 2 is incremented by one. The displayed numbers of the counter 10 are formed by all the counting gears 2.

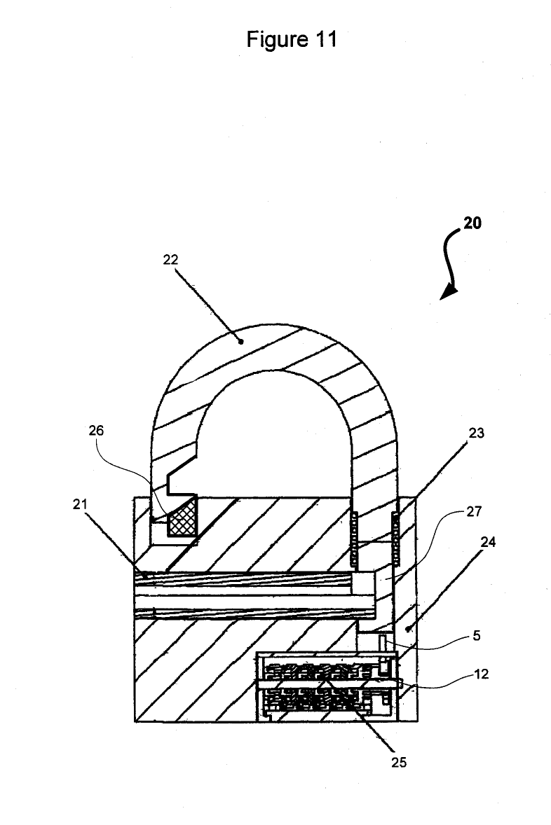

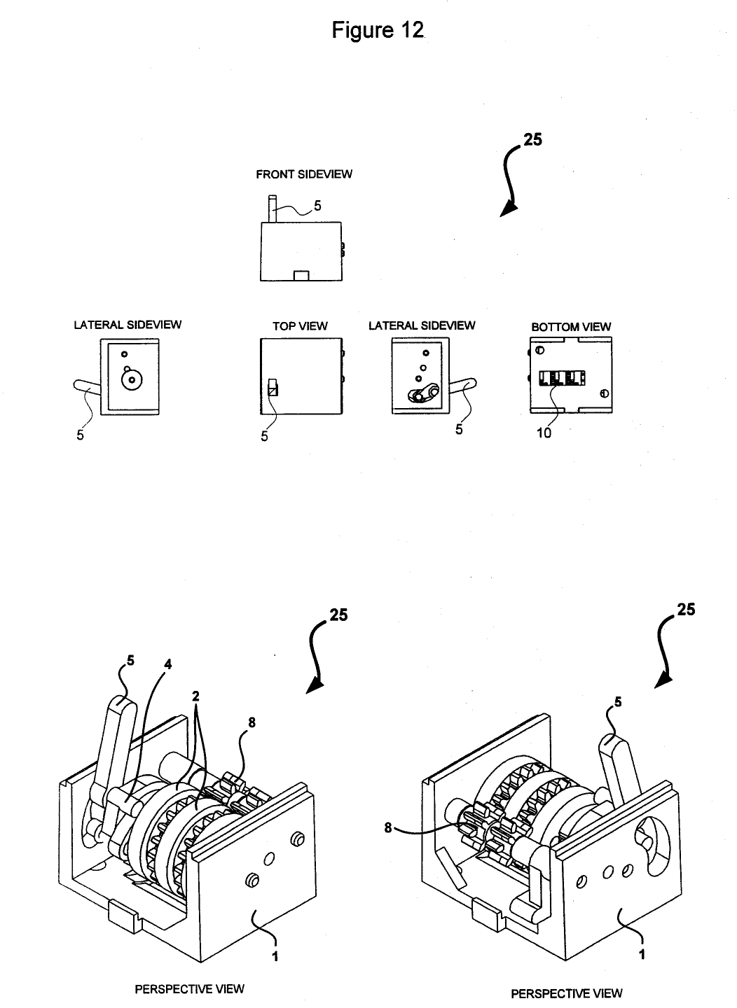

Referring specifically to FIGS. 10 and 11, the lock 20 comprises a lock body/housing 24, hasp 22, lock core 21, and the counting device 25. A key (not shown) is inserted into a lock core 21 and the key is turned to unlock the lock 20. The hasp 22 disengages from the latch 26, which allows the spring 23 to bias the hasp 22 outwardly and completes the lock-opening procedure. The key is unable to be removed from lock core 21 in this state.

The lock-closing procedure is initiated when the hasp 22 engages the latch 26 to lock the lock 20. The key need not be present in the lock core 21. The counting device 25 is activated in response the actuator 5 being actuated to complete a single digit recording. The digits shown in the visual indication 10 vary through the movement of the counting device 25. The digits of the visual indication 10 change in increasing sequential order and the lock-closing procedure is completed. The key may be removed from lock core 21 at this time to complete the lock-closing procedure. After the lock-closing procedure is completed, the digits displayed after the lock-closing procedure may be memorized to serve as evidence if the digits are not the same when checked again later. If the digits are different later, it means that the lock 20 has been unlocked and relocked at least once. The difference between the present number and the memorized number will indicate the number of times the lock 20 has been relocked.

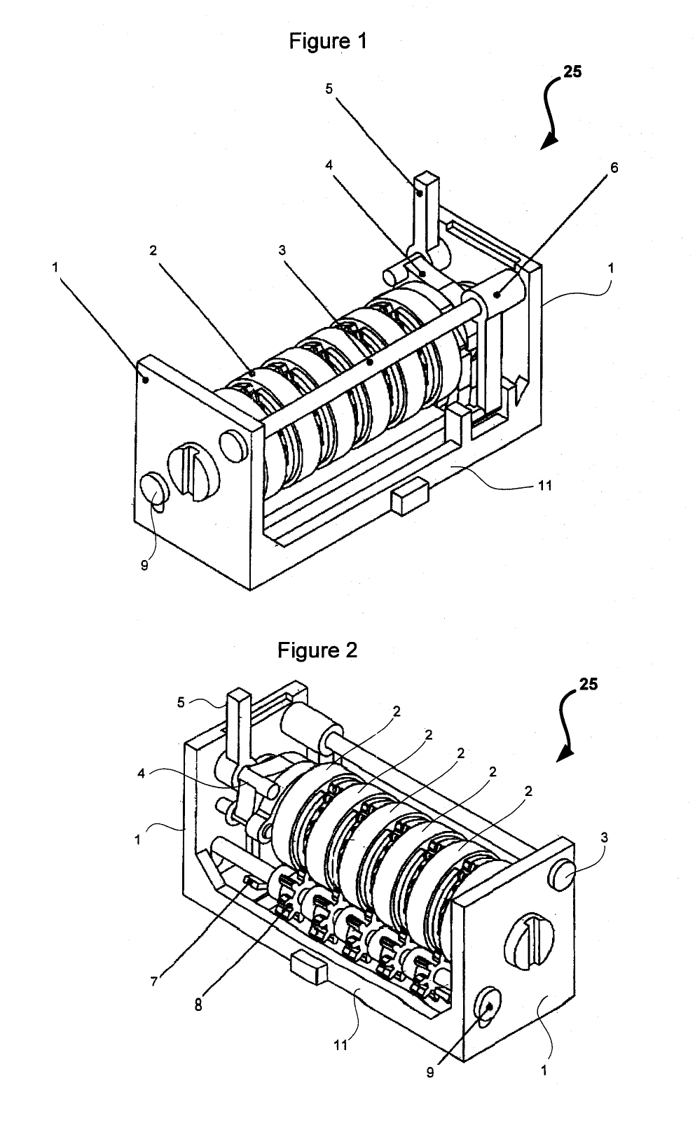

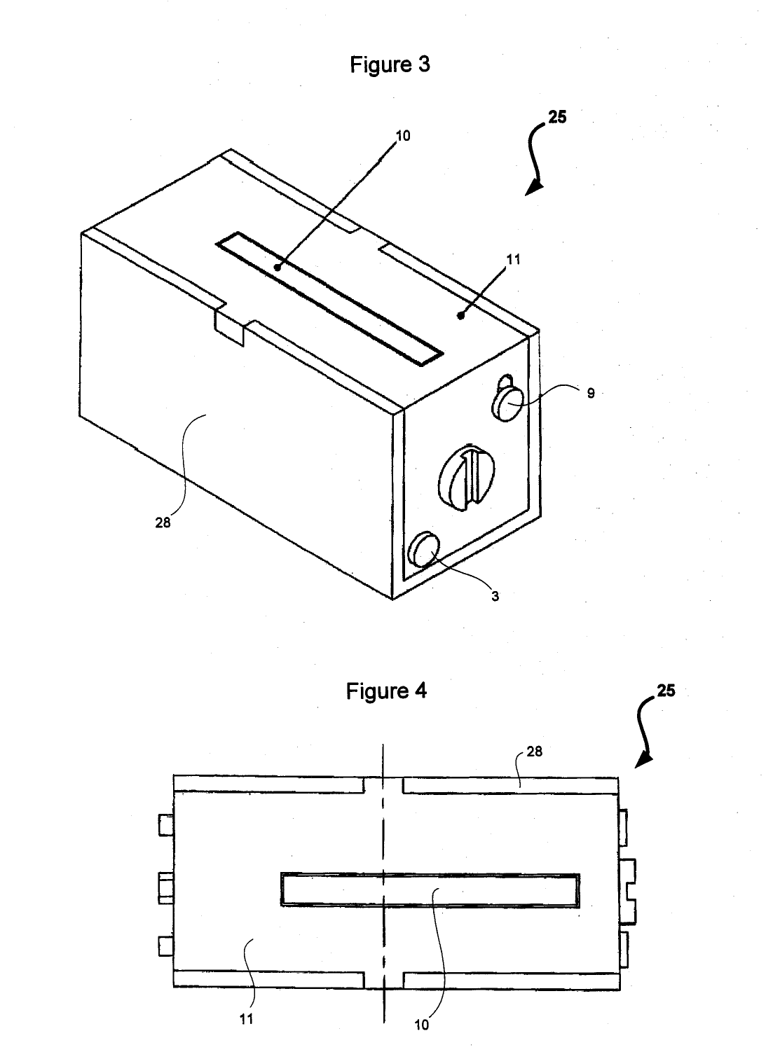

Referring specifically to FIG. 12, a mechanical counting device 25 with two shafts rather than three shafts is illustrated. In contrast to the first embodiment described and illustrated in FIGS. 1 to 11, this second embodiment does not have a stop spindle 3. This reduces complexity and lowers manufacturing costs.

Although the entry of the lock core 21 is described and illustrated as positioned at the sidewall of the lock 20, it is possible that the entry of the lock core 21 is on the same side as the visual indication 10 of the counting device 25.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

What is claimed:

1. A mechanical counting device provided within a lock, the lock including a latch and a hasp, wherein when the latch is engaged with the hasp, the lock is locked, and when the hasp is released from the latch, the lock is unlocked, the counting device comprising:
an actuator to actuate in response to the hasp engaging with the latch; and
a visual indication to visually indicate whether the lock has been relocked;
wherein each actuation of the actuator causes the visual indication to alter and indicate that the lock has been relocked another time.

2. The device according to claim 1, wherein the actuator is pivotally connected to rotational lever biased by a spring, and actuation of the actuator causes the rotational lever to incrementally rotate the visual indication.

3. The device according to claim 1, wherein the visual indication is a numeric counter.

4. The device according to claim 1, wherein the device is provided at the base of the lock, and the visual indication is visible through a transparent portion at the base of the lock.

5. The device according to claim 1, further comprising:
lateral sidewalls;
a counting gear;
a counting rotation lever;
a stop lever to stop the counting gear returning back to its original position when the actuator is actuated; and
a carry-over pinion;
wherein actuating the actuator causes the counting rotation lever to move and the counting gear to rotate, a counting gear spindle is reset back to zero, the carry-over pinion is propped against and driving the counting gear to perform carry-over, and an elastic plate is propped against a carry-over pinion spindle to move within a hole in the lateral sidewalls.

6. A lock, comprising:
a latch and a hasp, wherein when the latch is engaged with the hasp, the lock is locked, and when the hasp is released from the latch, the lock is unlocked; and
a mechanical counting device having an actuator to actuate in response to the hasp engaging with the latch, and having a visual indication to visually indicate whether the lock has been relocked;
wherein each actuation of the actuator causes the visual indication to alter and indicate that the lock has been relocked another time.

7. The lock according to claim 6, further comprising an elongate member to be pushed by the hasp to actuate the actuator when the latch engages the hasp.

8. A device to be operatively connected to a lock, the device being mechanically actuated in response to relocking the lock, the device comprising:
a visual indication to visually indicate that the lock has been relocked at least once;
an actuator to actuate the visual indication;
wherein relocking the lock causes the actuator to actuate the visual indication to visually indicate that the lock has been relocked at least once.

9. The device according to claim 8, wherein the visual indication is a numeric counter.

10. The device according to claim 8, wherein the device comprises a housing having a transparent portion to enable the visual indication to be seen.

11. The device according to claim 10, wherein the actuator is an elongate arm extending through an aperture formed in the housing, the arm being pushed inwardly to actuate the visual indication.

12. The device according to claim 11, wherein the arm is biased by a spring to partially extend out from the housing via an aperture.

13. A method for unlocking a lock, the method comprising:
visually indicating that the lock has been relocked at least once using a visual indication;
actuating the visual indication;
wherein locking the lock causes the actuator to actuate the visual indication to visually indicate that the lock has been relocked at least once.
